(19) United States
(12) Patent Application Publication
(10) Pub. No.: US 2020/0362704 A1
(43) Pub. Date: Nov. 19, 2020

(54) NOZZLE SEGMENT

(71) Applicant: Solar Turbines Incorporated, San Diego, CA (US)

(72) Inventors: Daniel Burnes, San Diego, CA (US); Tyson M. Ferguson, Encinitas, CA (US)

(73) Assignee: Solar Turbines Incorporated, San Diego, CA (US)

(21) Appl. No.: 16/415,950

(22) Filed: May 17, 2019

(51) Int. Cl. F01D 5/18; F01D 9/04

(52) U.S. Cl. CPC F01D 5/187; F05D 2240/30; F05D 2220/32; F01D 9/047

(57) ABSTRACT

A nozzle segment for a gas turbine engine with turbine airflow passing through the gas turbine engine. The nozzle segment including an upper shroud and an inner hub. The nozzle segment including a first airfoil and second airfoil extending from the upper shroud to the inner hub. The first airfoil and second airfoil including conduits for delivering secondary air to displace a portion of the turbine airflow passing through the gas turbine engine.

### TECHNICAL FIELD

The present disclosure generally pertains to a gas turbine engine, and is more particularly directed toward a nozzle segment for a gas turbine engine.

### BACKGROUND

A control attribute for some gas turbine engines is to target a primary zone temperature (TPZ) within the combustor at different operational conditions, including part load, when the engine is in low emissions mode. For a single shaft gas turbine, this can be enabled by adjusting compressor variable geometry as a degree of freedom along with fuel flow to hold power and a target TPZ at a part load condition. For a two shaft gas turbine, the engine can use overboard bleed along with fuel flow to hold power and a target TPZ at a part load condition.

European patent EP 1,489,265 to Beverley describes a turbine nozzle assembly for a gas turbine engine comprising a turbine nozzle including an outer band, an inner band, and a plurality of airfoil vanes coupled together by the outer and inner bands, each airfoil vane is hollow and defines a cavity therein. A manifold ring extends circumferentially around the turbine nozzle for channeling cooling fluid radially inwardly into each airfoil vane cavity. The manifold ring comprises a radially outer wall and a radially inner wall) coupled together by a pair of sidewalls, wherein at least a portion of the radially inner wall extends arcuately between the pair of sidewalls.

The present disclosure is directed toward overcoming known problems and/or problems discovered by the inventors.

### SUMMARY

A nozzle segment for a gas turbine engine is disclosed herein. The gas turbine engine includes turbine airflow. The nozzle segment comprises an upper shroud, an inner hub opposite the upper shroud, a first airfoil extending from the upper shroud to inner hub, and a second airfoil extending from the upper shroud to the inner hub.

The first airfoil includes a first leading edge, a first trailing edge opposite the leading edge, a first pressure side wall extending from the first leading edge to the first trailing edge, a first suction side wall extending from the first leading edge to the first trailing edge, and a first vane cavity between the upper shroud, inner hub, first pressure side wall, and the first suction side wall. The first airfoil further including a plurality of first suction side conduits extending through the suction side wall and in flow communication with the first vane cavity.

The second airfoil includes a second leading edge, a second trailing edge opposite the leading edge, a second pressure side wall extending from the second leading edge to the second trailing edge, a second suction side wall extending from the second leading edge to the second trailing edge, and a second vane cavity between the upper shroud, inner hub, second pressure side wall, and the second suction side wall. The second airfoil further includes a plurality of second pressure side conduits extending through the pressure side wall and in flow communication with the second vane cavity. The second pressure side conduits are located opposite from the plurality of first suction side conduits with respect to the turbine airflow.

### BRIEF DESCRIPTION OF THE DRAWINGS

FIG. 1 is a schematic illustration of a sectional view of an exemplary gas turbine engine;

FIG. 2 illustrates a portion of the turbine and a nozzle assembly of FIG. 1;

FIG. 3 illustrates a perspective view of a nozzle segment from the nozzle assembly from FIG. 2;

FIG. 4 illustrates a perspective view from the opposite direction of the first airfoil from FIG. 3; with the upper shroud and inner hub removed;

FIG. 5 illustrates a cross-sectional view of the vanes from FIG. 3 along plane V-V, the inner hub is not shown.

FIG. 6 illustrates a cross-section of an alternative first airfoil and second airfoil similar to the first airfoil and second airfoil of FIG. 3 along plane V-V, the inner hub is not shown.

FIG. 7 illustrates a cross-section of another alternative first airfoil and second airfoil similar to the first airfoil and second airfoil of FIG. 3 along plane V-V, the inner hub is not shown.

FIG. 8 illustrates the cross-sectional view of the first airfoil and second airfoil from FIG. 5, showing the secondary air flow through the first airfoil and second airfoil.

### DETAILED DESCRIPTION

The detailed description set forth below, in connection with the accompanying drawings, is intended as a description of various embodiments and is not intended to represent the only embodiments in which the disclosure may be practiced. The detailed description includes specific details for the purpose of providing a thorough understanding of the embodiments. However, it will be apparent to those skilled in the art that the disclosure without these specific details. In some instances, well-known structures and components are shown in simplified form for brevity of description. Some of the surfaces have been left out or exaggerated for clarity and ease of explanation.

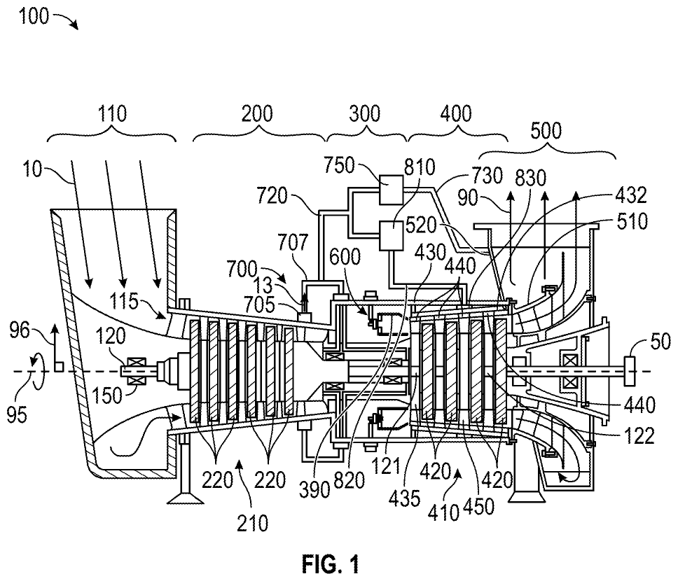

FIG. 1 is a schematic illustration of an exemplary gas turbine engine. Several of the elements shown are commonly shared elements and to improve the clarity and readability some of the reference numbers are not shown here and in other figures. As such, several exemplary features of the gas turbine engine 100 will be initially discussed for context.

The present disclosure may use the gas turbine engine 100 for orientation purposes. In particular, the disclosure may reference a center axis 95 of rotation of the gas turbine engine 100, which may be generally defined by the longitudinal axis of its shaft 120. Thus, all references to radial, axial, and circumferential directions and measures refer to the center axis 95, unless specified otherwise, and terms such as “inner” and “outer” generally indicate a lesser or greater radial distance from the center axis 95, wherein a radial 96 may be in any direction perpendicular and radiating outward from center axis 95. Furthermore, the disclosure may generally reference a forward and an aft direction, where references to “forward” and “aft” are associated with the axial flow direction of air 10 (i.e., air used in the combustion process), unless specified otherwise. For example, forward is “upstream” relative to the flow of air 10, and aft is “downstream” relative to the flow of air 10.

Regarding the exemplary gas turbine engine 100, generally, the gas turbine engine 100 includes an inlet 110, a compressor 200, a combustor 300, a turbine 400, an exhaust 500, and a power output coupling 50. The compressor 200 includes one or more rotating compressor rotor assemblies 220 populated with compressor blades. The turbine 400 includes one or more rotating turbine rotor assemblies 420 populated with turbine blades, turbine diaphragms 435, and nozzle assemblies 440. The exhaust 500 includes an exhaust diffuser 510 and an exhaust collector 520.

As illustrated, both compressor rotor assembly 220 and turbine rotor assembly 420 are axial flow rotor assemblies, where each rotor assembly includes a rotor disk that is circumferentially populated with a plurality of airfoils (“rotor blades”). When installed, the rotor blades associated with one rotor disk are axially separated from the rotor blades associated with an adjacent disk by nozzle assemblies (“stationary vanes”, “nozzle vanes”, or “nozzles”) 250, 440 circumferentially distributed in an annular casing.

The gas turbine engine 100 may also include a starter configured to rotate the rotating components without combustion. The starter may be mechanically coupled to the shaft 120 at the power output coupling 50, or at any other convenient location.

One or more of the rotating components are coupled to each other and driven by one or more shafts 120. The one or more shafts 120 may include a compressor shaft 121 and a turbine shaft 122 axially separated in the downstream direction from the compressor shaft 121. The one or more shafts 120 are supported by a plurality of bearing assemblies 150, which may be identified in any convenient manner.

As illustrated, the combustor 300 may include a combustion chamber 390 or “liner”. Depending on its configuration, the combustor 300 may include one or more of the above components. For example, the combustor 300 may include a plurality of injectors 600 annularly distributed around the center axis 95.

In operation, air 10 enters the gas turbine engine 100 via its inlet 110 as a “working fluid”, and is compressed by the compressor 200. In the compressor 200, the working fluid is compressed by the series of compressor rotor assemblies 220. In particular, the air 10 is compressed in numbered “stages”, the stages being associated with each compressor rotor assembly 220. For example, “4th stage air” may be associated with the 4th compressor rotor assembly 220 in the downstream or “aft” direction. While only five stages are illustrated here, the compressor 200 may include many more stages or fewer stages.

When compressed, air 10 may be used as needed: for combustion, for cooling, for pressurization, etc. In particular, the compressed air 10 may be diverted and become secondary air 13 depending on where the air is used. Air 10 is used in the combustion process. Air 10 is discharged from the compressor 200, enters the combustor 300 for combustion.

Similar to the compressor rotor assemblies 220, the turbine rotor assemblies 420 and nozzle assemblies 440 can be positioned in numbered “stages”. The stages can be associated with the position of each turbine rotor assembly 420 and nozzle assembly 440 in the order that they received combusted air. For example, 3^{rd} stage combusted air may be associated with a third stage nozzle assembly 450 of the nozzle assemblies 440. Alternatively, the stages can be associated with the position of each turbine rotor assembly 420 and nozzle assembly 440 in the order that they are received by the turbine shaft 122. For example, the nozzle assemblies 440 can include a first power turbine stage nozzle assembly 450 that represents the first nozzle assembly 440 located proximate to the turbine shaft 122.

The combusted air enters into the turbine 400 and drives the compressor shaft 121, thus driving the compressor 200. The combusted air progresses within the turbine 400 and drives the turbine shaft 122, thus generating power to for power output coupling 50. This portion of the turbine 400 can be referred to as a power turbine section. In an embodiment the compressor shaft 121 and turbine shaft 122 are separated proximate a 3^{rd} stage of the turbine 400.

After the combusted air transitions to exhaust gas 90 it can be diffused in exhaust diffuser 510 and collected and redirected to exit the gas turbine engine 100 via an exhaust collector 520.

Secondary air 13 is air provided throughout gas turbine engine 100 via a secondary air system 700 (or “bleed system”) for auxiliary uses such as pneumatic actuation, internal cooling, etc. In particular, the secondary air system 700 may tap one or more stages of compressor 200 and route the pressurized secondary air 13 via any combination of ducting, internal passageways, interstices between components, and any other air channels or secondary air passage 707.

The air system 700 may include one or more compressor ports 705 that tap the compressor at one or more locations. The compressor ports 705 are pneumatically coupled to the secondary air passage 707. The secondary air passage 707 can then distribute secondary air 13 as needed. For example, secondary air passage 707 may be in flow communication with a bleed tube 720 and provide compressed secondary air 13 to a bleed valve 750 and a control valve 810.

When the bleed valve 750 is open (e.g., during engine start up) the bleed valve acts as a turbine bypass that ducts secondary air 13 from the secondary air system 700 directly to the exhaust 500 via bleed valve passage 730, relieving back pressure on the compressor 200.

The control valve 810 can be controlled to allow secondary air 13 to enter the control valve passage 820. Though one control valve passage 820 is shown, there can be multiple control valve passages 820. The control valve passages 820 can extend through an outer wall 430 of the turbine 400 and allow secondary air 13 to enter into a manifold 830 at several different locations.

The secondary air system 700 may further include a network of air flow paths configured to distribute and deliver secondary air 13 at different pressure levels. For example, intermediate pressure secondary air 13 may be ported from an intermediate stage (e.g., 6th stage air) of the compressor 200 via intermediate pressure secondary air passage 707. In addition, high pressure secondary air 13 may be ported from a subsequent or final stage of the compressor 200 via high pressure or pressure at compressor discharge (PCD) secondary air passage 707. Different and/or additional stages may be tapped as a compressed air supply.

Alternatively, the compressed air supply may come from “shop air” (i.e., an air supply other than the gas turbine engine 100) or a combination of “shop air” and compressed air supplied by the gas turbine engine 100.

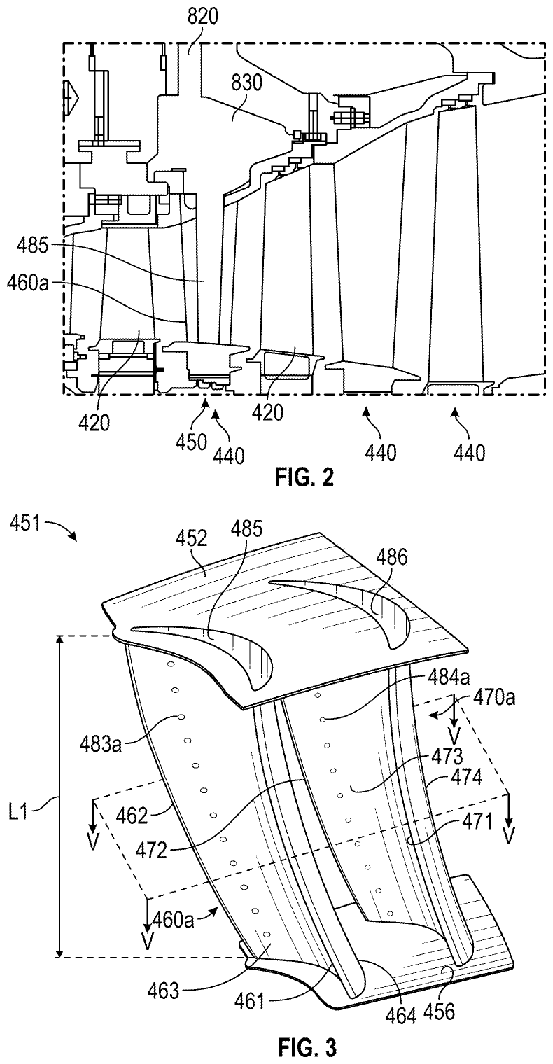

FIG. 2 illustrates a portion of the turbine of FIG. 1. The control valve passage 820 can extend into a portion of the turbine 400 to manifold 830. The manifold 830 can be in fluid communication with the control valve passage 820. The manifold 830 can extend outward of and circumferentially around one or more of the nozzle assemblies 440 and an inner wall 432 of turbine 400. In an embodiment the manifold 830 extends outward and circumferentially around the nozzle assembly 450 located at a third stage of the turbine 400. The nozzle assembly 450 can be located in the first stage of the power turbine section, for example, a first power turbine stage. In other embodiments, nozzle assembly 450 is located within another turbine stage. The nozzle assembly 450 can include a plurality of nozzle segments such as nozzle segment 451 shown in FIG. 3. The nozzle segment can include a first airfoil 460a and a first vane cavity 485. The first vane cavity 485 be in flow communication and receive secondary air 13 from the manifold 830.

FIG. 3 is a perspective view of a nozzle segment 451 for the gas turbine engine 100 of FIG. 2. Nozzle segment 451 includes upper shroud 452, inner hub 456, first airfoil 460a, and second airfoil 470a. In other embodiments, nozzle segment 451 can include more or fewer airfoils. Upper shroud 452 may be located adjacent and radially inward from inner wall 432 when nozzle segment 451 is installed in gas turbine engine 100.

Inner hub 456 is located radially inward from upper shroud 452. The inner hub 456 may also be located adjacent and radially outward from turbine diaphragm 435 when nozzle segment 451 is installed in gas turbine engine 100.

First airfoil 460a extends between upper shroud 452 and inner hub 456 at an airfoil length of L1. First airfoil 460a includes first leading edge 461, first trailing edge 462, first pressure side wall 463, and first suction side wall 464. First leading edge 461 extends from upper shroud 452 to inner hub 456. First trailing edge 462 is located opposite from the first leading edge 461 and extends from upper shroud 452 to the inner hub 456. When nozzle segment 451 is installed in gas turbine engine 100, first leading edge 461 may be located axially forward and upstream of first trailing edge 462. First leading edge 461 may be the point at the upstream end of first airfoil 460a with the maximum curvature and first trailing edge 462 may be the point at the downstream end of first airfoil 460a with maximum curvature.

First pressure side wall 463 may span from first leading edge 461 to first trailing edge 462 between upper shroud 452 and inner hub 456. First pressure side wall 463 may include a concave shape with respect to a plane that extends from the first leading edge 461 and the first trailing edge 462. First suction side wall 464 may also span from first leading edge 461 to first trailing edge 462 between upper shroud 452 and inner hub 456. First suction side wall 464 may include a convex shape with respect to a plane that extends from the first leading edge 461 and the first trailing edge 462. First leading edge 461, first trailing edge 462, first pressure side wall 463, first suction side wall 464, and upper shroud 452 may define the first vane cavity 485 that can be a hole, holes, or pathways for secondary air 13 to enter the first vane cavity 485 from the manifold 830. In other words the first vane cavity 485 is between the upper shroud 452, inner hub 456, second leading edge 461, second trailing edge 472, second pressure side wall 473, and second suction side wall 474.

The first pressure side wall 463 may include first pressure side conduits 483a extending from the first vane cavity 485 and extend through the first pressure side wall 463. The pressure side conduits 483a may be located proximate first trailing edge 462. First pressure side conduits 483a may be generally aligned in the radial direction between upper shroud 452 and inner hub 456, such as a radial column. In other examples the first pressure side conduits 483a can be oriented in multiple radial columns or can be staggered along the first pressure side wall 463 with respect to the first leading edge 461 and first trailing edge 462. The first pressure side conduits 483a, such as a radial column of first pressure side conduits 483a, can be positioned between the trailing edge 462 and leading edge 461 along the first pressure side wall 463. The first pressure side conduits 483a may comprise a variety of shapes including a cylindrical shape, a truncated shape such as a frusto-conical, pyramidal shape, spherical shape, or other shapes. The shape of the first pressure side conduits 483a can remain similar, may vary between each first pressure side conduits 483a, or a combination of both. The cross-sectional area of the first pressure side conduits 483a with respect to the first pressure side wall 463 can be similar or vary between each first pressure side conduits 483a. In an embodiment, the radial spacing between each of the first pressure side conduits 483a can be similar. In another example, the radial spacing of the first pressure side conduits 483a can vary between each first pressure side conduits 483a.

In an embodiment, nozzle segment 451 includes second airfoil 470a. Second airfoil 470a may include the same or similar features as first airfoil 460a shown in FIG. 3 and other figures including second leading edge 471, second trailing edge 472, second pressure side wall 473, second suction side wall 474, and second vane cavity 486. Second airfoil 470a may further include second pressure side conduits 484a. The description of second leading edge 471, the second trailing edge 472, second pressure side wall 473, second suction side wall 474, second vane cavity 486, and the second pressure side conduits 484a may be the same or similar as first leading edge 461, first trailing edge 462, first pressure side wall 463, first suction side wall 464, first vane cavity 485, and first pressure side conduits 483a respectively. In other embodiments, nozzle segment 451 only includes first airfoil 460a and not second airfoil 470a. In other embodiments, nozzle segment 451 includes multiple airfoils such as a third airfoil, a fourth airfoil, a fifth airfoil, or more airfoils.

The various components of nozzle segment 451 including upper shroud 452, inner hub 456, first airfoil 460a, and second airfoil 470a may be integrally cast or metalurgically bonded to form a unitary or one piece assembly thereof.

One or more of the above components (or their subcomponents) may be made from stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, alloy x, INCONEL, WASPALOY, RENE alloys, HAYNES alloys, alloy 188, alloy 230, INCOLOY, MP98T, TMS alloys, and CMSX single crystal alloys.

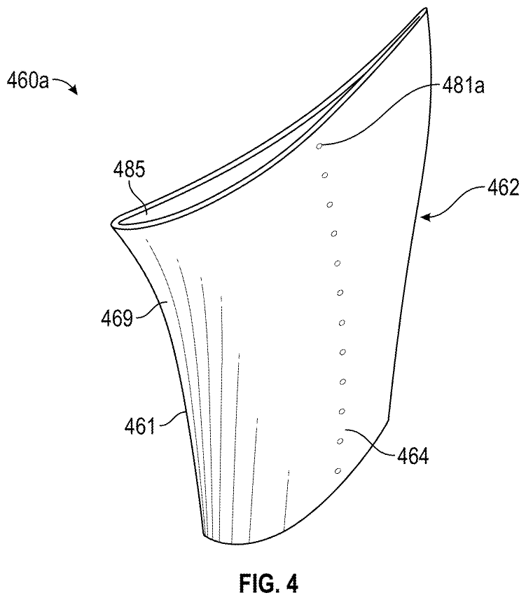

FIG. 4 illustrates a perspective view from the opposite direction of the first airfoil from FIG. 3, with the upper shroud and inner hub removed. The first airfoil 460a may include a grouping of first suction side conduits 481a. Each first suction side conduit 481a can extend from the first vane cavity 485 through the first suction side wall 464. In an embodiment, first suction side conduits 481a are arranged in a single radial column and spaced apart radially. In other examples the first suction side conduits 481a can be oriented in multiple radial columns or can be staggered along the first suction side wall 464 with respect to the first leading edge 461 and first trailing edge 462. The first suction side conduits 481a, such as a radial column of first suction side conduits 481a, can be positioned between the trailing edge 462 and leading edge 461 along the first suction side wall 464. The first suction side conduits 481a may comprise a variety of shapes including a cylindrical shape, a truncated shape such as a frusto-conical, pyramidal shape, spherical shape, or other shapes. The shape of the first suction side conduits 481a can remain similar, may vary between each of the first suction side conduits 481a, or a combination of both. The cross-sectional area of the first suction side conduits 481a with respect to the first suction side all 464 can be similar or vary between each first suction side conduits 481a. The radial spacing between each of the first suction side conduits 481a can be similar. In another example, the radial spacing of the first suction side conduits 481a can vary between each of the first suction side conduits 481a.

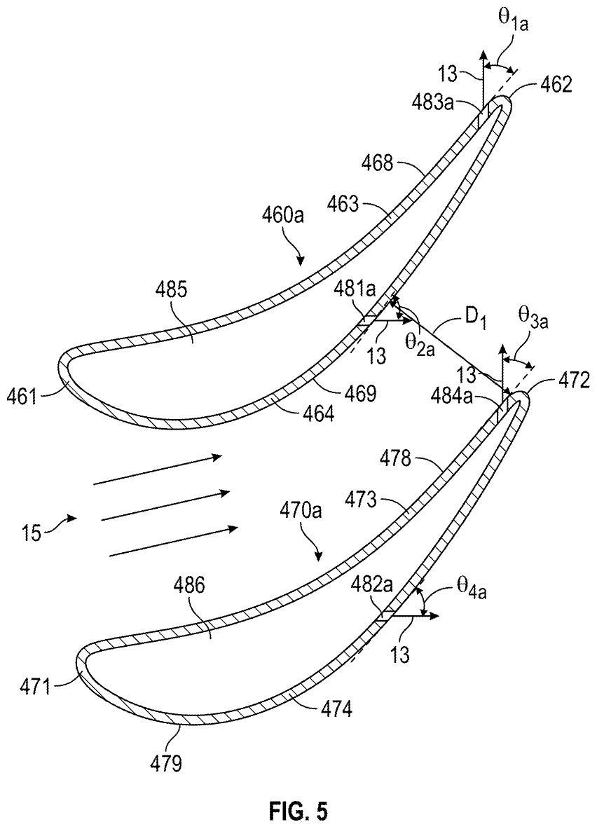

Though not shown, the second airfoil 470a shown in FIG. 3 may include the same or similar features as first airfoil 460a shown in FIG. 4 such as second suction side conduits 482a (shown in FIG. 5). The description of the second suction side conduits 482a may be the same or similar as first suction side conduits 481a.

FIG. 5 illustrates a cross-section of the first airfoil 460a and second airfoil 470a of FIG. 3 along plane V-V, the inner hub is not shown. The second trailing edge 472 of the second airfoil 470a can be spaced from the first suction side wall 464 of the first airfoil 460a at a distance D1, as known as the throat width. The distance D1 can generally be the shortest distance between the first suction side wall 464 of the first airfoil 460a and the second trailing edge 472 of the second airfoil 470a. The length of the airfoils L1 (see FIG. 3) can be multiplied with the distance D1 to produce an effective area between the first airfoil 460a and the second airfoil 470a. A turbine airflow 15 represents the flow of combusted air through the turbine 400 between the first airfoil 460a and second airfoil 470b. The turbine airflow 15 can have an effective flow that equals the mass of the flow divided by the density of the flow fluid and the mass of the flow further divided by the average velocity of the flow.

The first suction side conduits 481a and second pressure side conduits 484a can be positioned opposite from each other with respect to the turbine airflow 15. In an embodiment, the first suction side conduits 481a are positioned proximate to a portion of the first suction side wall 464, the portion of the first suction side wall 464 located at the shortest distance from the second trailing edge 472 of the second airfoil 470a. In an embodiment, the first suction side conduits 481a are positioned upstream of a portion of the first suction side wall 464, the portion of the first suction side wall 464 located at the shortest distance from the second trailing edge 472 of the second airfoil 470a.

The first suction side wall 464 may also include a first suction side surface 469 that is the outer surface of first suction side wall 464, with a convex shape with respect to a plane that extends from the first leading edge 461 to the first trailing edge 462, perpendicular to plane V-V.

The second pressure side wall 473 may also include a second pressure side surface 478 that is the outer surface of second pressure side wall 473, with a concave shape in respect to a plane that extends from the second leading edge 471 to the second trailing edge 472, perpendicular to plane V-V.

The second pressure side conduits 484a can extend through the second pressure side wall 473 and be in flow communication with the second vane cavity 486. The second pressure side conduits 484a may direct secondary air 13 at a second pressure side secondary air angle θ3a. Second pressure side secondary air angle θ3a may be the angle of the directed secondary air 13 with respect to a plane tangent to second pressure side surface 478 at the location of each second pressure side conduits 484a, the plane extending from the location of the second pressure side conduits 484a generally towards the second trailing edge 472. In one embodiment, the second pressure side secondary air angle θ3a is approximately 45 degrees. In one embodiment, the second pressure side secondary air angle θ3a is from 45 to 90 degrees. In an example the second pressure side secondary air angle θ3a can be between 1 and 90 degrees and the second pressure side conduits 484a can direct secondary air 13 to flow generally downstream and with the turbine airflow 15 passing between the second airfoil 470a and the second airfoil 470a. In an embodiment, the second pressure side conduits 484a can be oriented in the same direction as the second pressure side secondary air angle θ3a and be parallel with the direction of the secondary air 13 exiting the second pressure side conduits 484a. In an example, second pressure side conduits 484a can be oriented in a different direction from the second pressure side secondary air angle θ3a and not parallel with the direction of the secondary air 13 exiting the second pressure side conduits 484a.

Though not shown, each of the second pressure side conduits 484a can be oriented to be radially towards or away from the center axis 95. For example, the second pressure side conduits 484a can extend radially outward from positioned adjacent the second vane cavity 486 to the second pressure side wall 473 and may direct secondary air 13 radially outward. In another example, the second pressure side conduits 484a can extend radially inward from positioned adjacent the second vane cavity 486 to the second pressure side wall 473 and may direct secondary air 13 radially inward. In another example, the second pressure side conduits 484a can extend along a similar radial distance from positioned adjacent the second vane cavity 486 to the second pressure side wall 473 and may direct secondary air 13 at a similar radial distance.

The first suction side conduits 481a can extend through the first suction side wall 464 and be in flow communication with the first vane cavity 485. The first suction side conduits 481a may also include a first suction side secondary air angle θ2a. First suction side secondary air angle θ2a may be the angle of first suction side conduits 481a with respect to a plane tangent to first suction side surface 469 at the location of each first suction side conduit 481a. In one embodiment, the first suction side secondary air angle θ2a is approximately 45 degrees. In one embodiment, the first suction side secondary air angle θ2a is from 45 to 90 degrees. In other words, the first suction side secondary air angle θ2a can be between 0 and 90 degrees and the first suction side conduits 481a can direct secondary air 13 to flow generally downstream and with the turbine airflow 15 passing between the first airfoil 460a and the second airfoil 470a. In an embodiment, the first suction side conduits 481a can be oriented in the same direction as the first suction side secondary air angle θ1a and be parallel with the direction of the secondary air 13 exiting the first suction side conduits 481a. In an example, first suction side conduits 481a can be oriented in a different direction from the first suction side secondary air angle θ1a and not parallel with the direction of the secondary air 13 exiting the first suction side conduits 481a.

Though not shown, each of the first suction side conduits 481a can be oriented to be radially towards or away from the center axis 95. For example, the first suction side conduits 481a can extend radially outward from positioned adjacent the first vane cavity 485 to the first suction side wall 464. In another example, the first suction side conduits 481a can extend radially inward from positioned adjacent the first vane cavity 485 to the first suction side wall 464. In another example, the first suction side conduits 481a can extend along a similar radial distance from positioned adjacent the first vane cavity 485 to the first suction side wall 464.

The first vane cavity 485 may be a single cavity. In other embodiments the first vane cavity 485 may be subdivided into multiple cavities. Similarly, the second vane cavity 486 may be a single cavity. In other embodiments the second vane cavity 486 may be subdivided into multiple cavities.

The first airfoil 460a and second airfoil 470a may include the same or similar features such as a first pressure side secondary air angle θ1a and a second suction side secondary air angle θ4a. The description of the a first pressure side secondary air angle θ1a and a second suction side secondary air angle θ4a may be the same or similar as second pressure side secondary air angle θ3a and first suction side secondary air angle θ2a, respectively.

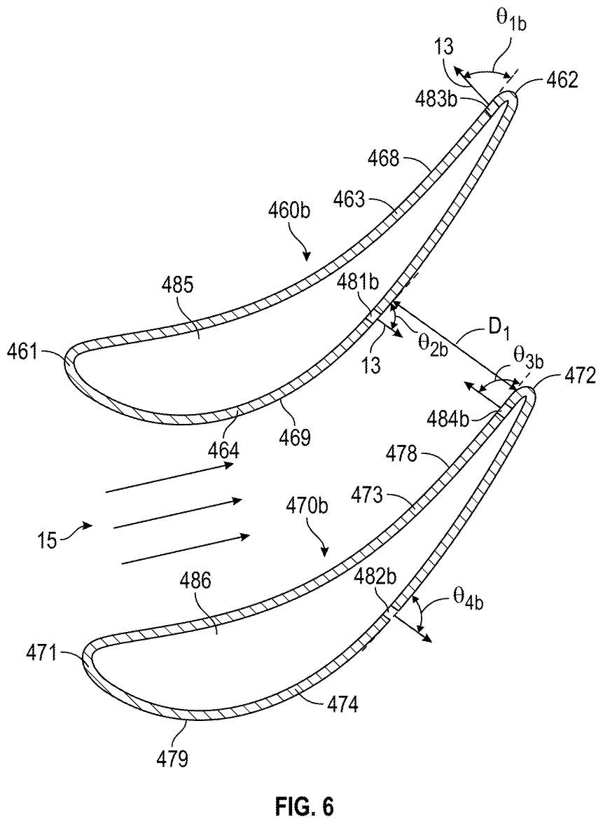

FIG. 6 illustrates a cross-section of an alternative first airfoil and second airfoil similar to the first airfoil and second airfoil of FIG. 3 along plane V-V. The inner hub 456 is not shown. The description of elements of the airfoils that are the same as those shown and described in connection with the earlier figures is not repeated.

In one embodiment, second pressure side conduits 484b can extend through the second pressure side wall 473 and be in flow communication with the second vane cavity 486. The second pressure side conduits 484b may direct secondary air 13 at a second pressure side secondary air angle θ3b. Second pressure side secondary air angle θ3b may be the angle of the directed secondary air 13 with respect to a plane tangent to second pressure side surface 478 at the location of each second pressure side conduits 484b, the plane extending from the location of the second pressure side conduits 484b generally towards the second trailing edge 472.

In one embodiment, the second pressure side secondary air angle θ3b is approximately 90 degrees. In other words the second pressure side secondary air angle θ3b is approximately perpendicular to the second pressure surface 478 adjacent to the second pressure side conduits 484b. In an embodiment the second pressure side secondary air angle θ3b can be generally neutral and the second primary conduits 484b can direct secondary air 13 to flow generally perpendicular to the turbine airflow passing 15 between the first airfoil 460b and the second airfoil 470b.

In an embodiment, the second pressure side conduits 484a can be oriented in the same direction as the second pressure side secondary air angle θ3a and be parallel with the direction of the secondary air 13 exiting the second pressure side conduits 484a. In an example, second pressure side conduits 484a can be oriented in a different direction from the second pressure side secondary air angle θ3a and be not parallel with the direction of the secondary air 13 exiting the second pressure side conduits 484a.

In an embodiment, the first suction side conduits 481b can extend through the first suction side wall 464 and be in flow communication with the first vane cavity 485. The first suction side conduits 481b may also include a first suction side secondary air angle θ2b. First suction side secondary air angle θ2b may be the angle of first suction side conduits 481b with respect to a plane tangent to first suction side surface 469 at the location of each first suction side conduit 481a.

In one embodiment, the first suction side secondary air angle θ2a is approximately 90 degrees. In one embodiment, the first suction side secondary air angle θ2a is approximately perpendicular to the first suction side wall 464. In an embodiment, the first suction side secondary air angle θ2b can be generally neutral and the first suction conduits 481b can direct secondary air 13 to flow generally perpendicular to the turbine airflow 15 passing between the first airfoil 460b and the second airfoil 470b.

In an embodiment, the first suction side conduits 481a can be oriented in the same direction as the first suction side secondary air angle θ2a and be parallel with the direction of the secondary air 13 exiting the first suction side conduits 481a. In an example, first suction side conduits 481a can be oriented in a different direction from the first suction side secondary air angle θ2a and not parallel with the direction of the secondary air 13 exiting the first suction side conduits 481a.

The first airfoil 460b and the second airfoil 470b may include the same or similar features such as a first pressure side secondary air angle θ1b and a second suction side secondary air angle θ4b. The description of the first pressure side secondary air angle θ1b and second suction side secondary air angle θ4b may be the same or similar as second pressure side secondary air angle θ3b and first suction side secondary air angle θ2b, respectively.

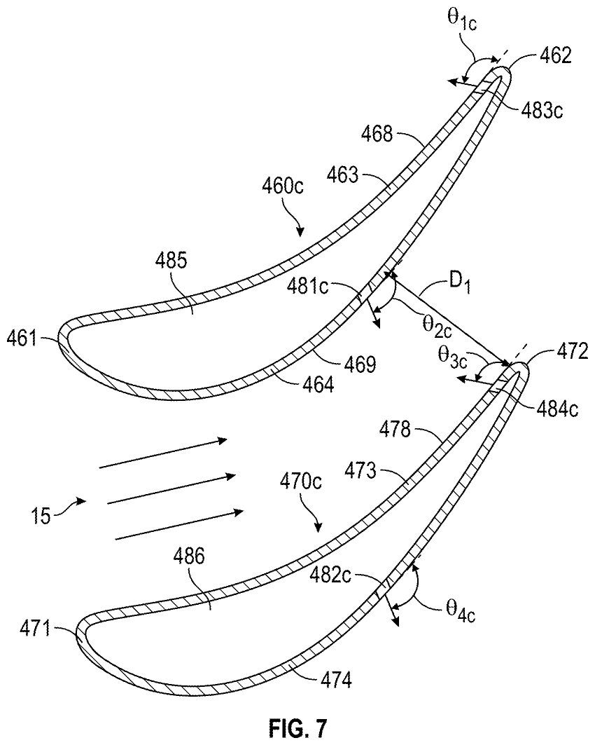

FIG. 7 is a cross-section of a further alternative first airfoil and second airfoil similar to the first airfoil and second airfoil of FIG. 3 along plane V-V. The description of elements of the airfoils that are the same as those shown and described in connection with the earlier figures is not repeated.

In an embodiment, second pressure side conduits 484c can extend through the second pressure side wall 473 and be in flow communication with the second vane cavity 486. The second pressure side conduits 484c may direct secondary air 13 at a second pressure side secondary air angle θ3c. Second pressure side secondary air angle θ3c may be the angle of the directed secondary air 13 with respect to a plane tangent to second pressure side surface 478 at the location of each second pressure side conduits 484c, the plane extending from the location of the second pressure side conduits 484c generally towards the second trailing edge 472.

In one embodiment, the second pressure side secondary air angle θ3c is approximately 135 degrees. In one embodiment, the second pressure side secondary air angle θ3c is from 90 to 135 degrees. In an embodiment the second pressure side secondary air angle θ3c can be between 90 and 179 degrees and the second pressure side conduits 484c can direct secondary air 13 to flow generally upstream and against the turbine airflow 15 passing between the second airfoil 470c and the second airfoil 470c.

In an embodiment, the second pressure side conduits 484c can be oriented in the same direction as the second pressure side secondary air angle θ3c and be parallel with the direction of the secondary air 13 exiting the second pressure side conduits 484c. In an example, second pressure side conduits 484c can be oriented in a different direction from the second pressure side secondary air angle θ3c and not parallel with the direction of the secondary air 13 exiting the second pressure side conduits 484c.

In an embodiment, first suction side conduits 481c can extend through the first suction side wall 464 and be in flow communication with the first vane cavity 485. The first suction side conduits 481c may also include a first suction side secondary air angle θ2c. First suction side secondary air angle θ2c may be the angle of first suction side conduits 481c with respect to a plane tangent to first suction side surface 469 at the location of each first suction side conduit 481c.

In one embodiment, the first suction side secondary air angle θ2c is approximately 135 degrees. In one embodiment, the first suction side secondary air angle θ2c is from 90 to 135 degrees. In an embodiment, the first suction side secondary air angle θ2c can be between 90 and 179 degrees and the first suction side conduits 481c can direct secondary air 13 to flow generally upstream and against the turbine airflow 15 passing between the first airfoil 460c and the second airfoil 470c.

In an embodiment, the first suction side conduits 481c can be oriented in the same direction as the first suction side secondary air angle θ1c and be parallel with the direction of the secondary air 13 exiting the first suction side conduits 481c. In an example, first suction side conduits 481c can be oriented in a different direction from the first suction side secondary air angle θ1c and not parallel with the direction of the secondary air 13 exiting the first suction side conduits 481c.

The first airfoil 460c and second airfoil 470c may include the same or similar features such as a first pressure side secondary air angle θ1c and a second suction side secondary air angle θ4c. The description of the a first pressure side secondary air angle θ1c and a second suction side secondary air angle θ4c may be the same or similar as second pressure side secondary air angle θ3c and first suction side secondary air angle θ2c, respectively.

It should be noted that depending on the desired performance characteristics, embodiments of the invention can utilize the various described secondary air angles in various combinations. For example a nozzle segment can include a first airfoil having a first suction side secondary air angle ranging from 90 to 135 degrees. The nozzle segment can further include a second airfoil having a second pressure side secondary air angle ranging from 1 to 90 degrees.

### INDUSTRIAL APPLICABILITY

The present disclosure generally pertains to a nozzle segment for a gas turbine engine, and is applicable to the use, operation, maintenance, repair, and improvement of gas turbine engines. The nozzle segment embodiments described herein may be suited for gas turbine engines for any number of industrial applications, such as, but not limited to, various aspects of the oil and natural gas industry (including transmission, gathering, storage, withdrawal, and lifting of oil and natural gas), the power generation industry, the aerospace industry and the transportation industry, to name a few examples.

Operating efficiency of a gas turbine engine 100 can generally improve by controlling and targeting a primary zone temperature (TPZ) within the combustor 300 at multiple operational conditions. Controlling the area between airfoils 460abc, 470abc of nozzle assembly 450 can provide an adjustable factor that facilitates matching a target TPZ and can help meet low emission objectives, such as for dry low emission (DLE) gas turbine engines, while maximizing gas turbine engine 100 efficiency.

Secondary air 13 can be provided by a compressed air supply, which may originate from the compressor 200, a “shop air” supply, or a combination of both. The control valve 810 can receive the secondary air 13 from the compressed air supply. The control valve 810 can be for modulating the amount of secondary air 13 that enters into a control valve passage 820 based on the target TPZ and the operational conditions of the turbine engine, such as during part loading or a fraction of the full loading capacity of the gas turbine engine 100 (e.g., approximately 50% of full loading capacity). The control valve 810 can be configured to regulate the amount of secondary air 13 provided to the nozzle segments 451 which make up one or more nozzle assemblies 450. The control valve 810 can operate based on a feedback loop of referencing measured temperature within the turbine 400 and the operating conditions of the gas turbine engine 100 such as at part load. There can be multiple control valve passages 820 that deliver the secondary air 13 to multiple locations along the manifold 830. The first vane cavity 485 and the second vane cavity 486 can be in flow communication with the manifold 830 and receive the secondary air 13. The secondary air 13 can flow from the vane cavities 485, 486, through conduits 481abc, 482abc, 483abc, 484abc, and into the turbine airflow 15 between the first airfoil 460abc and the second airfoil 470abc.

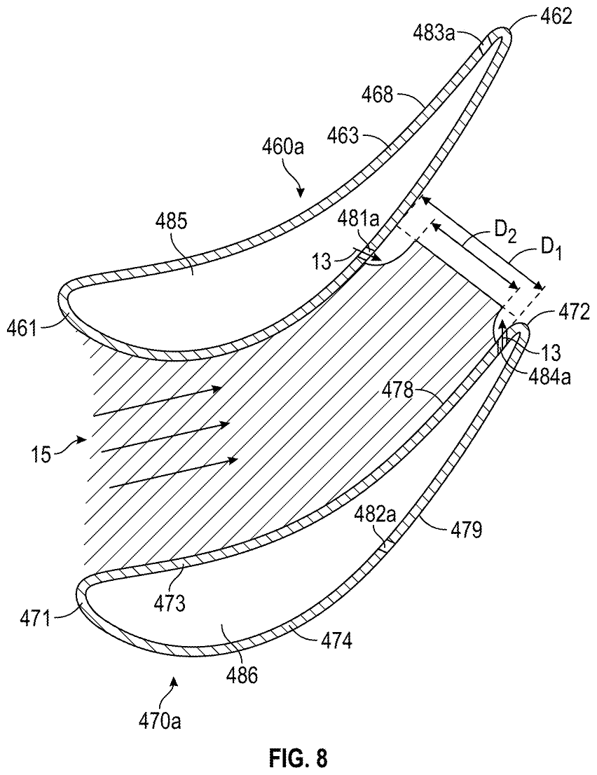

FIG. 8 illustrates the cross-sectional view of FIG. 5, showing the secondary air flow through the first airfoil and second airfoil.

The amount of turbine airflow between airfoils 460a, 470a is a least partially reliant on an effective distance between airfoils D2, also referred to as the throat width, which can be the shortest distance between the first airfoil 470a and the second airfoil 480a. The effective distance between the first air foil 470a and the second airfoil 480a can equal the mass of the flow divided by the density of the flow fluid, the mass of the flow further divided by the average velocity of the flow, and the mass of the flow further divided by the length of the airfoil s L1. The reduction of effective distance D2 can reduce the effective flow area, which can reduce the amount of turbine airflow 15 between airfoil 460a, 470a and can lead to improvements in thermal efficiency of the turbine during part loading.

In an embodiment shown, the conduits 481a, 484a can be for controllably blocking or displacing the turbine airflow 15 passing between the first airfoil 460a and the second airfoil 470a of the gas turbine engine 100 by directing secondary air 13 into the turbine airflow 15. In other words the directed secondary air 13 flows through the conduits 481a, 484a and is directed into the turbine airflow 15 and reduces the effective distance D2 for the turbine airflow 15 to move through. The conduits 481a, 484a can be positioned to provide combined effective distance D2 reduction from the directed secondary air 13. The position of the conduits 481a, 484a can be selected to control the displacement effect of the turbine airflow 15 due to the secondary air 13 directed from the conduits 481a, 484a. The amount of secondary air 13 supplied through the conduits 481a, 484a, can be adjusted by the control valve 810 to adjust the displacement effect provided by the secondary air 13 via conduits 481a, 484a. The conduits 481a, 484a can be oriented at secondary air angles θ2a, θ3a, respectively to allow the secondary air 13 to be delivered in a downstream direction of the turbine airflow 15. The secondary air 13 can displace the turbine airflow 15 by having a different vector direction with respect to the turbine airflow 15. The secondary air 13 can create a vortex or an eddy that takes up space and prevents the turbine airflow 15 from passing through an area located adjacent to the conduits 481a, 482a. Each adjacent pair of airfoils can operate in a similar or the same manner.

The embodiments depicted in FIG. 6 and FIG. 7 can be operated in a similar manner.

The conduits 481b, 484b shown in FIG. 6 can be oriented at an secondary air angle θ2b, θ3b respectively to allow secondary air 13 to be directed neutral to or generally perpendicular to the turbine airflow 15. The generally perpendicular orientation of conduits 481b, 482b can increase the blocking effect of the conduits in comparison to downstream orientation conduit.

The conduits 481c, 484c in FIG. 7 can be oriented at a secondary air angle θ1c, θ3c respectively to allow secondary air 13 to be directed upstream into the turbine airflow 15. The upstream orientation of conduits 481c, 484c can increase the blocking effect of the conduits 481c, 482c in comparison to conduits neutral or downstream orientation.

The first pressure side conduits 483a,b,c and second pressure side conduits 484a,b,c can be positional along the length of the pressure side wall 463,473 of the first and second airfoil 460a,b,c, 470a,b,c. In an example the first pressure side conduits 483a,b,c and second pressure side conduits 484a,b,c are positioned proximate to the trailing edge 462, 472.

The first suction side conduits 481a,b,c and second suction side conduits 482a,b,c can be positional along the length of the suction side wall 464, 474 of the first and second airfoil 460a,b,c, 470a,b,c. In an example the first suction side conduits 481a,b,c are positioned opposite of the second pressure side conduits 484a,b,c with respect to the turbine airflow 15.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular nozzle segment, it will be appreciated that the nozzle segment in accordance with this disclosure can be implemented in various other configurations, can be used with various other types of gas turbine engines, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

1. A nozzle segment for a gas turbine engine, the gas turbine engine including a turbine airflow passing through the gas turbine engine during operation of the gas turbine engine, the nozzle segment comprising:
an upper shroud;
an inner hub opposite the upper shroud;
a first airfoil extending from the upper shroud to the inner hub, the first airfoil including
a first leading edge,
a first trailing edge opposite the first leading edge,
a first pressure side wall extending from the first leading edge to the first trailing edge,
a first suction side wall extending from the first leading edge to the first trailing edge,
a first vane cavity between the upper shroud, inner hub, first pressure side wall, and the first suction side wall,
a plurality of first suction side conduits extending through the first suction side wall and in flow communication with the first vane cavity; and
a second airfoil extending from the upper shroud to the inner hub; the second airfoil including
a second leading edge,
a second trailing edge opposite the second leading edge,
a second pressure side wall extending from the second leading edge to the second trailing edge,
a second suction side wall extending from the second leading edge to the second trailing edge,
a second vane cavity between the upper shroud, inner hub, second pressure side wall, and the second suction side wall, and
a plurality of second pressure side conduits extending through the second pressure side wall and in flow communication with the second vane cavity, the second pressure side conduits located proximate the second trailing edge and opposite from the plurality of first suction side conduits with respect to the turbine airflow.

2. The nozzle segment of claim 1, wherein the plurality of first suction side conduits and the plurality of second pressure side conduits are positioned to direct secondary air into the turbine airflow to controllably displace the turbine airflow.

3. The nozzle segment of claim 1, wherein the first suction side wall includes a first suction side surface that is an outer surface of the first suction side wall, and the plurality of first suction side conduits are oriented from 90 to 179 degrees with respect to a plane tangent to the first suction side surface at a location of the plurality of first suction side conduits, the plane extending from the plurality of first suction side conduits toward the first trailing edge.

4. The nozzle segment of claim 3, wherein the second pressure side wall includes a second pressure side surface that is an outer surface of the second pressure side wall, and the plurality of second pressure side conduits are oriented from 90 to 179 degrees with respect to a plane tangent to the second pressure side surface at a location of the plurality of second pressure side conduits, the plane extending from the plurality of second pressure side conduits toward the second trailing edge.

5. The nozzle segment of claim 1, wherein the gas turbine engine further comprises a turbine with a first power turbine stage; and
wherein the nozzle segment is positioned within the first power turbine stage.

6. The nozzle segment of claim 1, wherein the gas turbine engine further comprises a turbine with a third stage; and
wherein the nozzle segment is positioned within the third turbine stage.

7. A nozzle segment for a gas turbine engine, the gas turbine engine including secondary air and a turbine airflow passing through the gas turbine engine during operation of the gas turbine engine, the nozzle segment comprising:
an upper shroud;
an inner hub opposite the upper shroud; and
a first airfoil extending from the upper shroud to the inner hub, the first airfoil including
a first leading edge,
a first trailing edge opposite the first leading edge,
a first pressure side wall extending from the first leading edge to the first trailing edge,
a first suction side wall extending from the first leading edge to the first trailing edge,
a first secondary air pathway,
a plurality of first suction side conduits extending through the first suction side wall and in flow communication with the first secondary air pathway;
a second airfoil extending from the upper shroud to the inner hub; the second airfoil including
a second leading edge,
a second trailing edge opposite the second leading edge,
a second pressure side wall extending from the second leading edge to the second trailing edge,
a second suction side wall extending from the second leading edge to the second trailing edge,
a second first secondary air pathway, and
a plurality of second pressure side conduits extending through the second pressure side wall and in flow communication with the second secondary air pathway, the second pressure side conduits located proximate the second trailing edge and opposite from the plurality of first suction side conduits with respect to the turbine airflow; and
wherein the first suction side conduits are located in a position closest to and opposite from the plurality of second pressure side conduits with respect to the turbine airflow.

8. (canceled)

9. The nozzle segment of claim 7, wherein the plurality of first suction side conduits and the plurality of second pressure side conduits direct the secondary air to reduce an effective distance for the turbine airflow to move through.

10. The nozzle segment of claim 7, wherein the first airfoil further comprises a first suction side surface, and the plurality of first suction side conduits are oriented generally perpendicular to the first suction side surface at a location of the plurality of first suction side conduits.

11. The nozzle segment of claim 10, wherein the second airfoil further comprises a second pressure side surface, and the plurality of second pressure side conduits are oriented generally perpendicular to the second pressure side surface at a location of the plurality of second pressure side conduits.

12. The nozzle segment of claim 7, wherein
the first suction side wall includes a first suction side surface that is an outer surface of the first suction side wall; and
wherein the plurality of first suction side conduits are oriented between 90 to 179 degrees with respect to a plane tangent to the first suction side surface at a location of the plurality of first suction side conduits and extending from the plurality of first suction side conduits generally towards the first trailing edge.

13. The nozzle segment of claim 12, wherein
the second pressure side wall includes a second pressure side surface that is an outer surface of the second pressure side wall; and
wherein the plurality of second pressure side conduits are oriented between 90 to 179 degrees with respect to a plane tangent to the second pressure side surface at a location of the plurality of second pressure side conduits and extending from the plurality of second pressure side conduits generally towards the second trailing edge.

14. A nozzle segment for a gas turbine engine, the gas turbine engine including secondary air and a turbine airflow passing through the gas turbine engine during operation of the gas turbine engine, the nozzle segment comprising:
an upper shroud;
an inner hub opposite the upper shroud;
a first airfoil extending from the upper shroud to the inner hub, the first airfoil including
a first vane cavity,
a first suction side wall, and
a plurality of first suction side conduits extending through the first suction side wall and in flow communication with the first vane cavity;
a second airfoil extending from the upper shroud to the inner hub, the second airfoil including
a trailing edge,
a second vane cavity,
a pressure side, and
a plurality of second pressure side conduits proximate the trailing edge, in flow communication with the second vane cavity and configured to direct a portion of the secondary air into the turbine airflow to reduce an effective distance between the first airfoil and the second airfoil for the turbine airflow to move through; and
wherein the plurality of first suction side conduits and the plurality of second pressure side conduits are located opposite from each with respect to the turbine airflow.

15. (canceled)

16. (canceled)

17. The nozzle segment of claim 15, wherein the first airfoil further comprises a first suction side surface, and the plurality of first suction side conduits are oriented generally perpendicular to the first suction side surface at a location of the plurality of the first suction side conduits.

18. The nozzle segment of claim 17, wherein the second airfoil further comprises a second pressure side surface, and the plurality of second pressure side conduits are oriented generally perpendicular to the second pressure side surface at a location of the plurality of second pressure side conduits.

19. The nozzle segment of claim 15, wherein the first airfoil further comprises:
a first leading edge;
a first trailing edge opposite the first leading edge;
a first suction side wall extending from the first leading edge to the first trailing edge, the first suction side wall having a first suction side surface that is an outer surface of the first suction side wall; and
wherein the plurality of first suction side conduits are oriented between 90 to 179 degrees with respect to a plane tangent to the first suction side surface at a location of the plurality of first suction side conduits and extending from the plurality of first suction side conduits generally towards the first trailing edge.

20. The nozzle segment of claim 19, wherein the second airfoil further comprises:
a second leading edge;
a second trailing edge opposite the first leading edge;
a second pressure side wall extending from the second leading edge to the second trailing edge, the second pressure side wall having a second pressure side surface that is an outer surface of the second pressure side wall; and
wherein the plurality of second pressure side conduits are oriented between 90 to 179 degrees with respect to a plane tangent to the second pressure side surface at a location of the plurality of second pressure side conduits and extending from the plurality of second pressure side conduits generally towards the second trailing edge.
